(19) United States
(12) Patent Application Publication
(10) Pub. No.: US 2025/0329085 A1
(43) Pub. Date: Oct. 23, 2025

(54) GENERATIVE ARTIFICAL INTELLIGENCE VISUAL EFFECTS

(71) Applicant: Adobe Inc., San Jose, CA (US)

(72) Inventors: Rishav Agarwal, Panathur (IN); Siddharth Srinivasan Iyer, San Francisco, CA (US); Shubbham Yadav, Gurgaon (IN); Sanyam Jain, New Delhi (IN); Oliver Brdiczka, San Jose, CA (US); Sudeep Siddheshwar Katakol, San Francisco, CA (US); David Davenport Bourgin, Brooklyn, NY (US); Aliakbar Darabi, Newcastle, WA (US)

(73) Assignee: Adobe Inc., San Jose, CA (US)

(21) Appl. No.: 18/677,874

(22) Filed: May 30, 2024

(30) Foreign Application Priority Data
Apr. 22, 2024 (IN) 202411031947

(51) Int. Cl. G06T 11/60; G06T 11/00

(52) U.S. Cl. CPC G06T 11/60; G06T 11/001; G06T 2200/24

(57) ABSTRACT

Generative artificial intelligence visual effect techniques are described. A prompt, for example, is received. The prompt includes text specifying a visual effect and text specifying a shape. A mask is formed defining a portion of digital content based on an object selected from digital content. The visual effect is generated using generative artificial intelligence by one or more machine-learning models based on the text specifying the visual effect, the text specifying the shape, and the mask. The digital content is presented as having the visual effect applied to the portion of the digital content for display in a user interface.

### RELATED APPLICATION

This application claims priority under 35 USC 119 to Indian application Ser. No. 20/241,1031947, filed Apr. 22, 2024, the disclosure of which is incorporated in its entirety.

### BACKGROUND

Visual effects are utilized to expand an expressiveness and creativity of digital content. Creatives, for instance, are continually driven to locate techniques usable to express inspiration in newfound and fresher ways in order to bridge a gap between imagination and what techniques are available to create a variety of digital content, e.g., digital documents, digital images, webpages, layouts, and so forth.

Although generative artificial intelligence techniques have been developed to expand functionality that is made available from a computing device, conventional generative artificial intelligence techniques often fail in complicated digital content creation scenarios. This failure frequently results in visual artifacts thereby causing the techniques to fail for an intended purpose as well as inefficient use of computational resources to correct these visual artifacts.

### SUMMARY

Generative artificial intelligence visual effect techniques are described. In one or more examples, a prompt is received that includes text specifying a visual effect and text specifying a shape. A mask is formed defining a portion of digital content based on an object selected from digital content, e.g., as a binary mask. The visual effect is generated using generative artificial intelligence by one or more machine-learning models based on the text specifying the visual effect, the text specifying the shape, and the mask. The digital content is presented as having the visual effect applied to the portion of the digital content for display in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ generative artificial intelligence visual effect techniques described herein.

FIG. 2 depicts a system in an example implementation showing operation of a visual effect generation system of FIG. 1 in greater detail as applying a visual effect generated using generative artificial intelligence to digital content.

FIG. 3 depicts a system in an example implementation showing operation of a mask generation module and a visual effect generation module of FIG. 2 in greater detail as generating a visual effect for application to a portion of digital content disposed between cells of a table.

FIG. 4 depicts a system in an example implementation showing operation of a mask generation module and a visual effect generation module of FIG. 2 in greater detail as generating a visual effect for application to a portion of digital content disposed between cells of a table.

FIG. 5 depicts a system in an example implementation showing operation of a mask generation module and a visual effect generation module of FIG. 2 in greater detail as generating a visual effect for application to an object configured as a vector object forming a stroke.

FIG. 6 depicts a system in an example implementation showing operation of a mask generation module and a visual effect generation module of FIG. 2 in greater detail as generating another visual effect for application to an object.

FIG. 7 depicts an example implementation in which a text description of a shape is generalized to control visual effect generation by the visual effect generation module of FIG. 2.

FIG. 8 depicts an example implementation in which a text description of a shape is detailed as describing characteristics of the shape to control visual effect generation by the visual effect generation module of FIG. 2.

FIG. 9 is a flow diagram depicting an algorithm as a step-by-step procedure in an example implementation of operations performable for accomplishing a result of visual effect generation using generative artificial intelligence as implemented using one or more machine-learning models.

FIG. 10 illustrates an example system including various components of an example device that can be implemented as any type of computing device as described and/or utilize with reference to the previous figures to implement embodiments of the techniques described herein.

### DETAILED DESCRIPTION

### Overview

Generative artificial intelligence utilizes machine-learning models to learn patterns and statistical properties from training digital content. The machine-learning models, once trained, are then usable to create instances of digital content based on a prompt, e.g., to create text, digital images, and so forth. However, conventional generative artificial intelligence techniques often fail in complicated digital content creation scenarios.

Consider a scenario in which a visual effect is to be generated based on a table, e.g., to define a layout within a webpage, catalog, brochure, and so forth. Conventional techniques used to generate a visual effect for a portion of digital content disposed between the cells of the table face numerous technical challenges. Conventional techniques, for instance, are typically limited to basic effects such as stroke color, weight, opacity, doted effect, wavy effect, or corner effects to specify borders of the cells that form the table.

Other techniques that have been employed by creatives involve manually selecting a digital image that is used to form a background. However, this technique generally lacks visual consistency with the cells of the table. The digital image, for instance, typically does not address an actual makeup of the table but rather is viewed independent of the table. Although generative artificial intelligence techniques have also been utilized, these techniques as conventionally implemented encounter numerous technical challenges resulting from a limited amount of space defined between the cells in the table and often appear to have a “cut out” appearance as a visual artifact that is readily noticeable by a human being.

Accordingly, generative artificial intelligence (AI) visual effect techniques are described that are implemented using one or more machine-learning models. These generative AI visual effect techniques address technical challenges involved in complicated digital content creation scenarios (e.g., such as those involving tables to define layouts, vector objects having complex shapes, and so on), which is not possible using conventional techniques.

The generative techniques described herein, for example, support photorealistic visual effects based on portions defined in relation to an object, e.g., a vector object. The generative techniques are usable to define a fill within a vector object, a portion disposed outside of a vector object (e.g., gaps between cells of a table), and so forth. Further, the generative techniques described herein are also usable to control an amount of creativity versus legibility of visual effects created by the machine-learning models, thereby giving a degree of user control that is not possible using conventional techniques.

In one or more examples, a prompt is received by a visual effect generation system. The prompt includes text specifying a shape and text specifying a visual effect. The text specifying the shape, for instance, is usable to control how a visual effect is generated, an amount of detail exhibited by the visual effect, and so forth. For example, the text specifying the shape is usable to provide insight and act as a guide as to “what” is receiving a visual effect, e.g., a “table,” a “chess knight,” and so forth. The text specifying the visual effect, on the other hand, identifies the visual effect to be applied, e.g., “jute rope,” “bundle of wires,” “melting cheese,” “jadeite stone,” and so forth.

Prompt engineering may also be utilized by the visual effect generation system to expand the prompt to include an additional item of text. For example, a user input that includes “a table” and “jute rope” is expandable by a large language model (LLM) using machine learning and natural language understanding to “a detailed photorealistic vector graphics rendition of a table made of jute rope on a white background.” In this way, operation of the machine-learning model by the visual effect generation system is biased towards visually appealing results by providing additional context.

The visual effect generation system also forms a mask defining a portion of digital content that is to be a subject of the visual effect. A user input, for instance, is received via a user interface as selecting a table. Therefore, the portion in this example defines areas of the digital content that are “outside” of cells used to form the table. In another instance, the user input selects a particular object, such as a vector object, raster object, and so on from the digital content. In either instance, the visual effect generation system then forms a mask defining the portion, e.g., as a binary mask in which a first color (e.g., black) indicates pixels that are not to receive the visual effect and a second color (e.g., white) indicates pixels that are to receive the visual effect.

The visual effect is then generated by the visual effect generation system using generative artificial intelligence by one or more machine-learning models.

To do so in one or more examples, the visual effect generation system first employs a generative model that is conditioned on both text and image embeddings, e.g., is a text-to-image machine-learning model such as “Dall-E.” A contribution image embedding is generated by the generative model based on the prompt, e.g., identifying the shape and the visual effect. The contribution image embedding is then used by a diffusion model to generate the visual effect for the portion based on the mask. The diffusion model, for instance, adds noise to the contribution image embedding as defined by the portion of the mask which is then denoised using the diffusion model to generate the visual effect, e.g., based also on the text identifying the shape and the visual effect.

In an implementation, an amount of noise applied by the visual effect generation system is adjustable to control an amount of creativity versus legibility applied by the diffusion model as part of generating the visual effect. An increased amount of noise as applied to the contribution image embedding, for instance, lowers an amount that the contribution image embedding constrains generation of the visual effect. In one or more examples, a control is output in the user interface to adjust the constraint imposed by the contribution image embedding and thus specify an amount of creativity versus legibility (e.g., “free reign”) to be applied by the diffusion model as part of the generating of the visual effect.

The visual effect generation system is also configurable to employ a swapping technique in which the contribution image embeddings are applied and are not applied for respective diffusion iterations by the diffusion model, e.g., for respective percentages of times. This swapping technique permits the diffusion model to operate while avoiding “cutout-like” visual artifacts of conventional generative artificial intelligence techniques, thereby improving operation and accuracy of the diffusion model. Once generated, the visual effect is applied to the portion of the digital content (e.g., based on the mask) and presented for display in a user interface. The visual effect generation system also supports subsequent edits, e.g., to redefine the portion to cause reapplication of the visual effect.

In this way, the generative AI visual effects techniques address technical challenges involved in complicated digital content creation scenarios (e.g., such as those involving tables), which is not possible using conventional techniques. Additionally, the generative techniques described herein are also usable to control an amount of creativity versus legibility of visual effects created by the machine-learning models based on different amounts of detail specified by the text describing the shape. This functionality supports a degree of user control that is not possible using conventional techniques. Further discussion of these and other examples are also contemplated, additional description of which is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the visual artifact generation techniques described herein. Example procedures are also described that are performable in the example environment as well as other environments. Consequently, performance of the example procedures is not limited to the example environment and the example environment is not limited to performance of the example procedures.

### Example Visual Effect Generation Environment

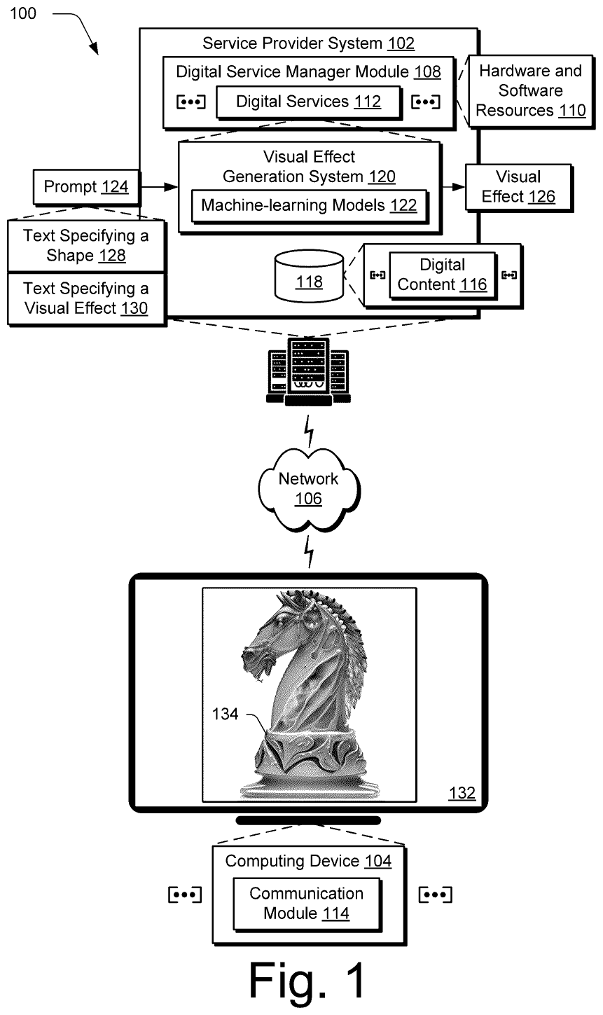

FIG. 1 is an illustration of a digital medium environment 100 in an example implementation that is operable to employ generative artificial intelligence visual effect techniques described herein. The illustrated environment 100 includes a service provider system 102 and a computing device 104 that are communicatively coupled, one to another, via a network 106. Computing devices are configurable in a variety of ways.

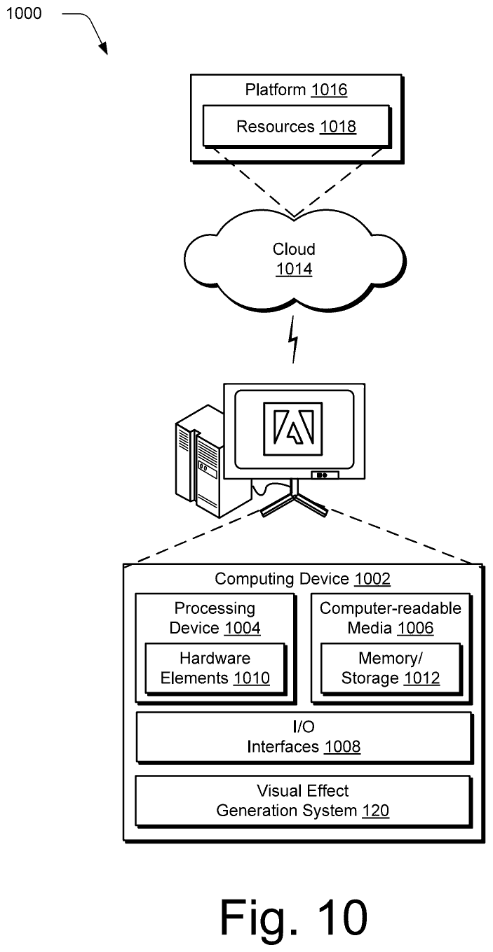

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 10.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

The service provider system 102 is further illustrated as maintaining digital content 116 in a storage device 118. Digital content 116 is configurable to take a variety of forms. Examples of these forms include a digital document, digital presentation, digital book, digital image, digital media, digital video, digital brochures, webpages, user interfaces, and so forth.

In the illustrated example, the digital services 112 are utilized to implement a visual effect generation system 120 implemented using one or more machine-learning models 122. The visual effect generation system 120 is configured to take, as an input, a prompt 124. The prompt 124 is configurable to include a variety of text, examples of which include text specifying a shape 128, text specifying a visual effect 130, and so on.

The prompt 124 is then processed using generative artificial intelligence (AI) by the one or more machine-learning models 122 to generate a visual effect 126 that is to be applied to the digital content 116. In the illustrated user interface 132, for instance, digital content includes an object 134 that has a visual effect applied to the object. A prompt 124 including text specifying a shape 128 as “a chess knight” and text specifying a visual effect 130 of “jadeite stone” causes the visual effect generation system 120 to create a visual effect of the chess knight as formed from the jadeite stone for display in a corresponding portion of the digital content 116.

Generative artificial intelligence, as previously described, utilizes the one or more machine-learning models 122 to learn patterns and statistical properties from training digital content. The machine-learning models 122, once trained, are then usable to create instances of digital content based on the prompt 124, which in this example is usable to generate a visual effect 126 to be applied to the digital content 116.

The visual effect generation system 120 supports creation of the visual effect 126 using generative artificial intelligence to apply styles or textures onto portions of the digital content (e.g., objects such as vector objects or raster objects) using simple textual prompts. Conventional techniques used to apply visual effects involve a painstaking and time consuming process. The visual effect generation system 120, on the other hand, supports generation of the visual effect 126 automatically and without user intervention. The visual effect generation system 120 is usable to support a variety of digital services 112 and functionality of the communication module 114, e.g., as a network-enabled application.

Graphic design is an ever evolving space and creatives continually explore techniques usable to express creativity and imagination. Conventional techniques that are made available to creatives to produce visual effects, however, involve specialized knowledge typically gained over a significant period of time. In the techniques described herein, however, the visual effect generation system 120 is configured to make this functionality available to novice creatives without a time-consuming process involving user interaction with conventional techniques that is often prone to error and thus computationally inefficient.

Consider a simple example of adding visual effects to a table having a plurality of cells. Conventional techniques provide limited options supporting basic effects involving stroke color, weight, opacity, dotted effect, wavy effect or corner effects. Another option involves use of a digital image as a background, which in practice is limiting, does not support customization, and typically results in a noticeable “cut out” effect. Further, generative artificial intelligence techniques often fail due to a complex nature of a table and space limitations between cells of the table and also yield “cut out” effects as visual artifacts that are readily noticeable by a human being.

Accordingly, the visual effect generation system 120 is configured to address these technical challenges to support visually compelling results using textual prompts. The visual effect generation system 120, for instance, supports functionality that is accessible by a novice creative to create photographically realist effects with minimal effort, which is not possible in conventional techniques. Further discussion of operation of the visual effect generation system 120 in generation of the visual effect 126 and examples of the visual effect 126 are described in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Visual Effect Generation using Generative AI

The following discussion describes generative artificial intelligence techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks.

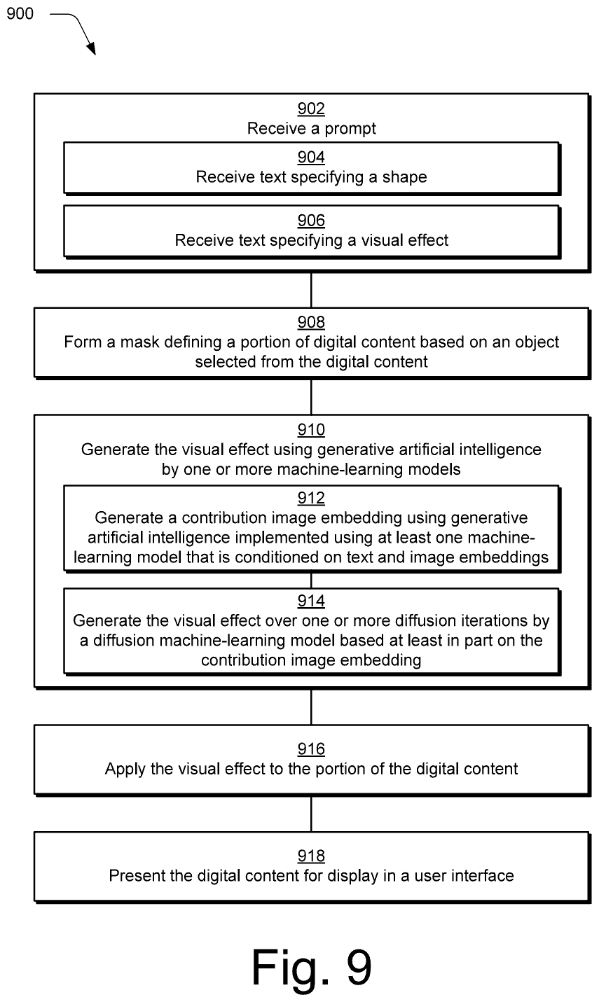

Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 9 is a flow diagram depicting an algorithm 900 as a step-by-step procedure in an example implementation of operations performable for accomplishing a result of visual effect generation using generative artificial intelligence as implemented using one or more machine-learning models. In portions of the following discussion, reference will be made to FIGS. 1-8.

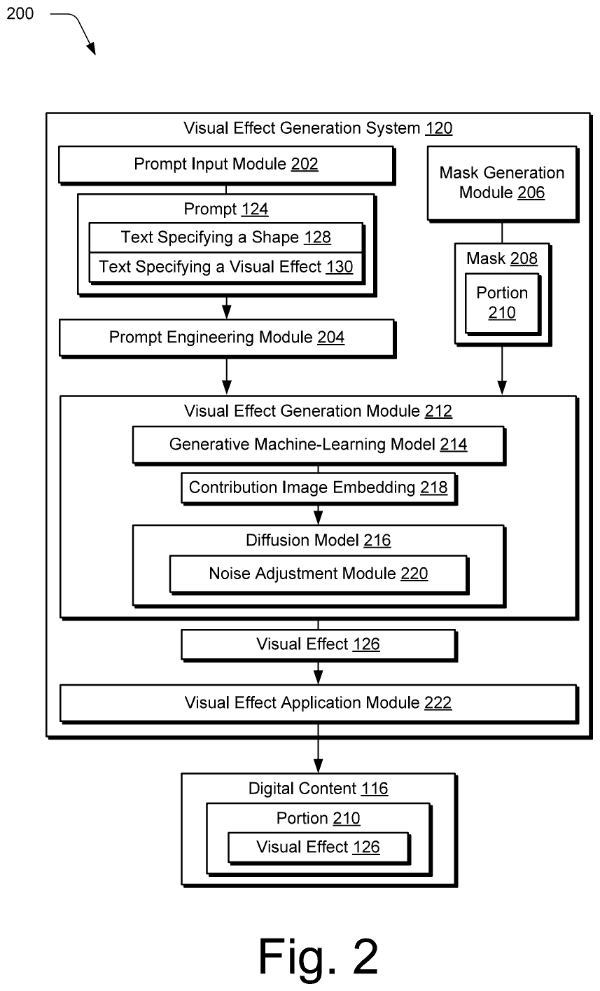

FIG. 2 depicts a system 200 in an example implementation showing operation of the visual effect generation system 120 of FIG. 1 in greater detail as applying a visual effect generated using generative artificial intelligence to digital content. A prompt input module 202 is employed to receive a prompt 124 (block 902), e.g., as text entered via a user interface output by the prompt input module 202. Receipt of the prompt 124 includes receipt of text specifying a shape 128 (block 904) and receipt of text specifying a visual effect 130 (block 906). Other examples are also contemplated, e.g., receipt of text solely describing either the shape or the visual effect.

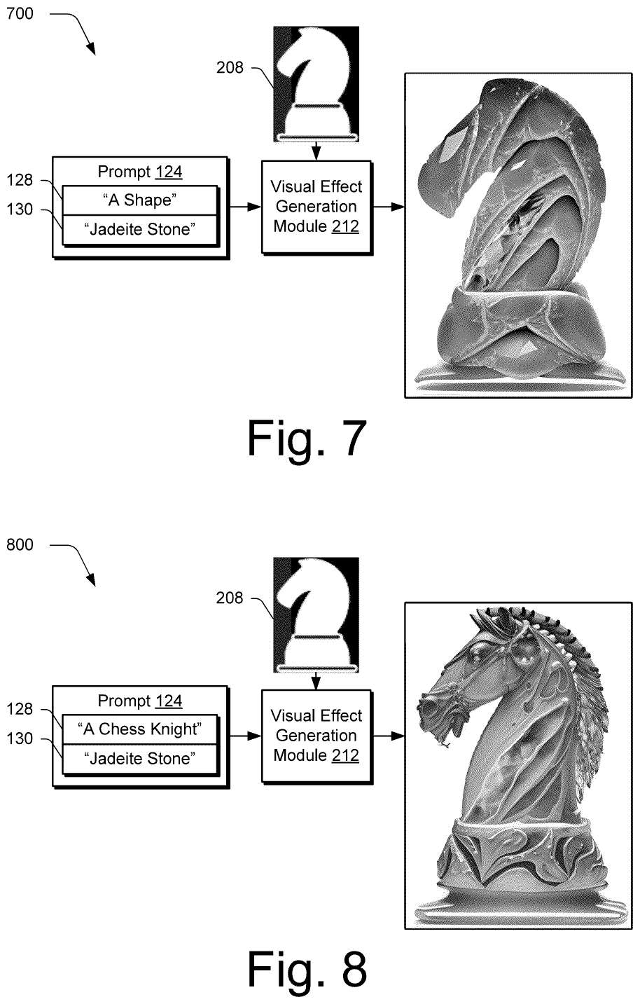

The text specifying the shape 128 is used as a guide to describe “what” is a subject of the visual effect. As further described below in relation to FIG. 7, for instance, a shape may be described generally (e.g., “a shape”) and thus does not influence how the visual effect 126 is applied. As shown in FIG. 8, on the other hand, the shape is described with specificity (e.g., “a chess knight”) and therefore the visual effect is generated to also depict the details of the shape.

In an implementation, the prompt 124 is expanded by a prompt engineering module 204 to include at least one additional item of text using a machine-learning model, e.g., using a large language model (LLM). The machine-learning model, as implemented by the prompt engineering module 204, is usable to analyze the prompt 124 to determine an intent and context expressed by the included text. The prompt engineering module 204 is also configurable to locate terms that are semantically similar to those in the prompt 124.

Through use of a large language model, for instance, the prompt engineering module 204 is configurable to employ chain-of-thought techniques to break down the prompt 124 to generate a range of related text items. For example, a prompt 124 including text specifying a shape 128 as “a table” and text specifying a visual effect 130 of “jute rope” is expanded by the prompt engineering module 204. The prompt 124, once expanded, includes additional items of text as “a detailed photorealistic vector graphics rendition of a table made of jute rope on a white background.” A variety of other examples are also contemplated.

The visual effect generation system 120 also includes a mask generation module 206. The mask generation module 206 is configured to form a mask 208 defining a portion 210 of digital content 116 based on an object selected from the digital content 116 (block 908). As previously described, the digital content 116 may take a variety of forms, examples of which include digital documents, digital images, spreadsheets, templates, layouts, and so forth.

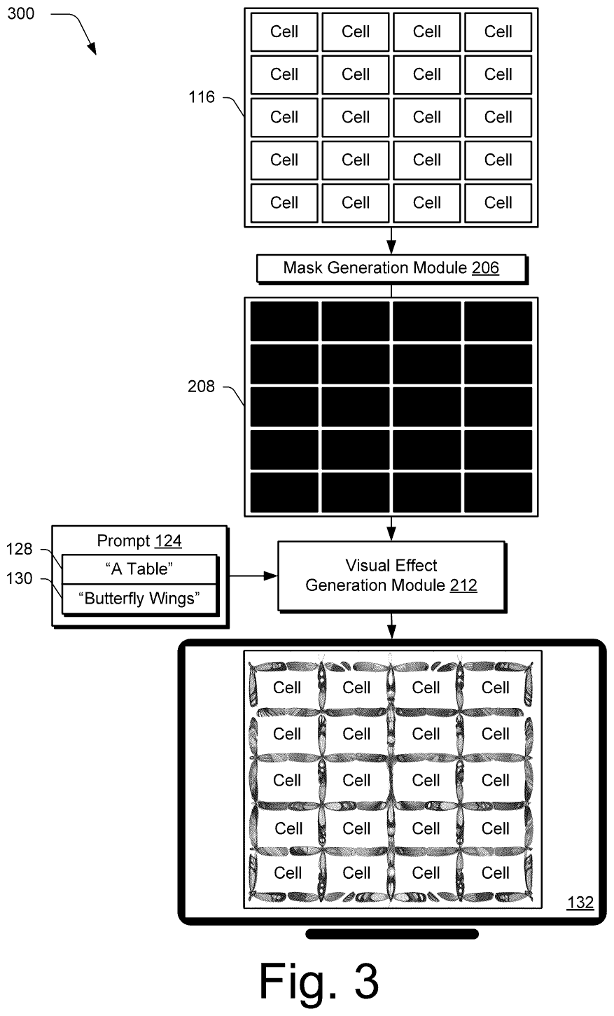

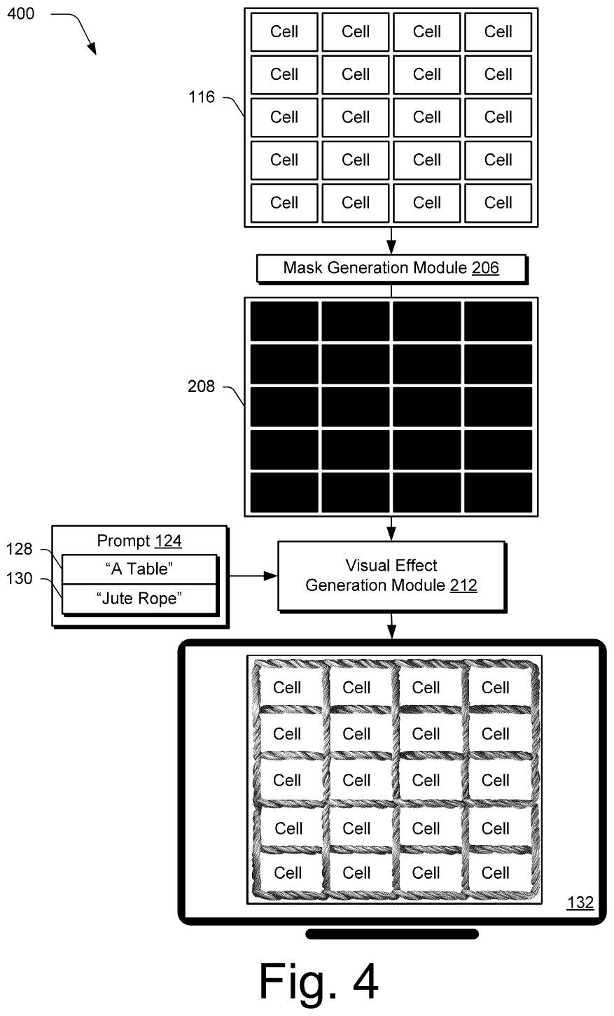

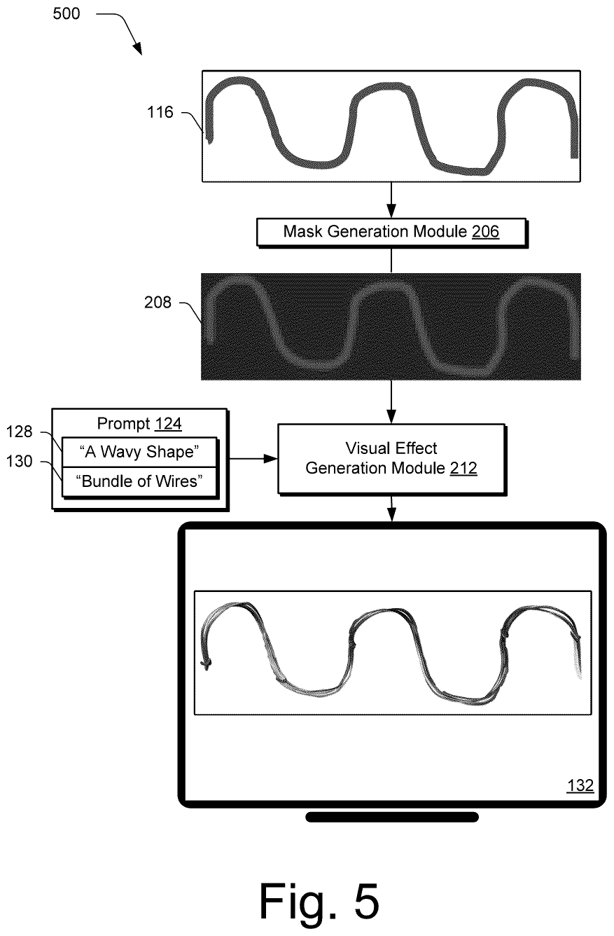

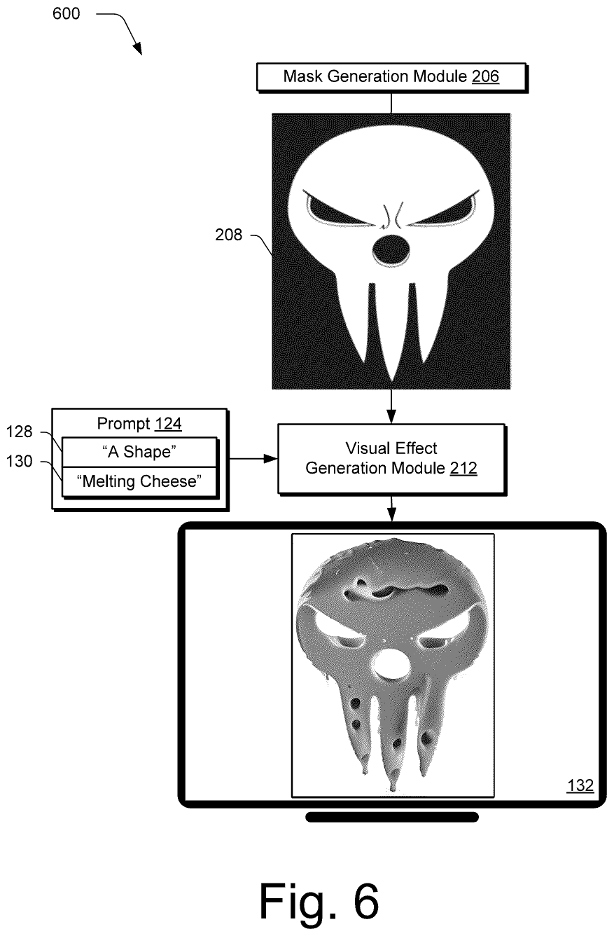

In one or more examples, an input is received via a user interface in a first example that selects an object from the digital content. Selection, for instance, may be input using a cursor control device, gesture, spoken utterance, and so forth to specify an object, such as a vector object, a raster object, and so forth. The object is then usable to specify the portion 210 of the digital content 116 this is to receive the visual effect. In a first example, the portion 210 is selectable directly (e.g., a stroke of FIG. 5, a skull of FIG. 6, a chess knight of FIGS. 7 and 8) or indirectly, e.g., a portion of the digital content that surrounds cells of the tables depicted in FIGS. 3 and 4.

The mask generation module 206 then forms the mask 208 by recoloring the portion 210 of the digital content using a first color (e.g., white) and remaining portions of the digital content using a second color (e.g., black) as a binary mask. The object, for instance, is configurable as a vector object which is then used to form the mask 208. In another instance, the object is a raster object that is then used directly and/or indirectly to form the mask 208, e.g., through conversion to a vector object based on a border of the raster object.

The mask 208 specifying the portion 210 and the prompt 124 (which may be expanded by the prompt engineering module 204) are then provided as inputs to a visual effect generation module 212 to generate the visual effect 126. The visual effect generation module 212 is configured to generate the visual effect 126, automatically and without user intervention, using generative artificial intelligence implemented using one or more machine-learning models 122 (block 910). To do so in this example, the one or more one or more machine-learning models 122 include a generative machine-learning model 214 configured to generate a contribution image embedding 218. The contribution image embedding 218 is then employed by a diffusion model 216 to generate the visual effect 126.

The generative machine-learning model 214, for instance, is conditioned (i.e., trained) on both text and image embeddings to generate a digital image based on the prompt 124, e.g., the text specifying the shape 128 and the text specifying the visual effect 130 (block 912). An example of a generative machine-learning model 214 is referred to as “DALL-E,” which denotes a series of AI models developed by OpenAIR that are trained using deep learning to generate a digital image from text that provides a natural language description. The generative machine-learning model 214 forms a contribution image embedding 218 as a representation of the generated image, e.g., as a numerical representation of the image encoded into a lower-dimensional vector space. In this way, the contribution image embedding 218 provides a compact representation of the digital image. The contribution image embedding 218, in one or more implementations, provides support for a consistent styling of the visual effect 126 by the visual effect generation module 212.

The contribution image embedding 218 is then provided by the generative machine-learning model 214 to a diffusion model 216 to generate the visual effect 126. The diffusion model 216, for instance, is configured to generate the visual effect 126 over one or more diffusion iterations based at least in part on the contribution image embedding (block 914). To do so, the diffusion model adds noise to the contribution image embedding 218. The contribution image embedding 218 is then used (e.g., along with the text specifying the shape 128, the text specifying the visual effect 130, and/or the mask 208) to generate the visual effect 126 for the portion 210 of the digital content 116.

In one or more implementations, the visual effect generation module 212 is further configured to protect against visual artifacts as part of generating the visual effect 126. In a first example, the diffusion model 216 employs a swapping technique such that contribution of the contribution image embedding 218 is added or removed for respective diffusion iterations during operation. Accordingly, the diffusion model 216 is configured to apply the contribution image embedding 218 in a first diffusion iteration and remove application of the contribution image embedding in a second diffusion iteration, i.e., “other” diffusion iteration. In this away, operation of the diffusion model 216 is not constrained in at least some of the diffusion iterations by the contribution image embedding 218, which supports improved creativity in operation of the diffusion model 216 and reduces “cut out” visual artifacts as encountered in conventional techniques.

In a second example, the diffusion model 216 employs a noise adjustment module 220 to adjust an amount of noise (e.g., Gaussian noise) applied to the contribution image embedding 218. In this way, like the example above, an amount that the contribution image embedding 218 contributes towards generation of the visual effect 126 may be adjusted, thereby also adjust an amount that generation of the visual effect 126 is constrained by the contribution image embedding 218. In one or more examples, this amount may be specified by a user input received via a control in the user interface. The control, for instance, is usable to specify an amount of creativity versus legibility to be applied as part of the generating of the visual effect 126 by the diffusion model 216 based on varying degrees of freedom achieved through adjusting the amount of noise. A variety of other examples are also contemplated.

The diffusion model 216, once generated, is passed as an input to a visual effect application module 222. The visual effect application module 222 is configured to apply the visual effect 126 to the digital content 116 (block 916), and more particularly the portion 210 of the digital content 116. The digital content is then presented for display in a user interface (block 918), e.g., user interface 132 as shown in FIG. 1. In one or more examples, the visual effect application module 222 supports a subsequent edit input that alters the portion 210 of the digital content and reapplies the visual effect 126 to the altered portion without regenerating the visual effect 126.

In this way, the visual effect 126 is conserved, thereby reducing computational resource consumption. The visual effect generation system 120 therefore supports a variety of usage scenarios based on the prompt 124 (e.g., the text specifying a shape 128 and/or the text specifying a visual effect 130) and the mask 208 indicating the portion 210 of the digital content 116 that is to be a subject of the visual effect 126.

FIG. 3 depicts a system 300 in an example implementation showing operation the mask generation module 206 and the visual effect generation module 212 of FIG. 2 in greater detail as generating a visual effect for application to a portion of digital content disposed between cells of a table. The digital content 116 is this example is configured as a digital document including a table. A selection input is received as selecting the object, e.g., the table via the user interface. A mask generation module 206 is then configured to generate a mask 208 in response to the selection input such that portions of the table that lie “outside” of the cells of the table are the subject of a visual effect 126.

A prompt 124 is received includes text specifying a shape 128 as “a table” and text specifying a visual effect 130 as “butterfly wings.” In response, the visual effect generation module 212 generates the visual effect 126 such that a portion of the digital content 116 that is disposed between the cells of the table appears as being formed from butterfly wings.

FIG. 4 depicts a system 400 in an example implementation showing operation of the mask generation module 206 and the visual effect generation module 212 of FIG. 2 in greater detail as generating a visual effect for application to a portion of digital content disposed between cells of a table. The digital content 116 is this example is also configured as a digital document including a table. A mask generation module 206 then generates a mask 208 such that portions of the table that lie “outside” of the cells of the table are the subject of a visual effect 126.

A prompt 124 is received that includes text specifying a shape 128 as “a table” and text specifying a visual effect 130 as “jute rope.” In response, the visual effect generation module 212 generates the visual effect 126 such that a portion of the digital content 116 that is disposed between the cells of the table appears as being formed from rope.

FIG. 5 depicts a system 500 in an example implementation showing operation of the mask generation module 206 and the visual effect generation module 212 of FIG. 2 in greater detail as generating a visual effect for application to an object configured as a vector object forming a stroke, e.g., using one or more Bezier curves. Like the previous example, a selection input is received as selecting an object (e.g., a stroke) from the digital content 116. In response, the mask generation module 206 forms a mask 208.

The prompt 124 includes text specifying a shape 128 as “a wavy shape” and text specifying a visual effect 130 as a “bundle of wires.” In response, the visual effect generation module 212 generates a visual effect 126 such that the object as the stroke is replaced to have an appearance of being formed from wires.

FIG. 6 depicts a system 600 in an example implementation showing operation of the mask generation module 206 and the visual effect generation module 212 of FIG. 2 in greater detail as generating another visual effect for application to an object configured as a vector object. A selection input is received as selecting an object (e.g., a skull) from the digital content 116. In response, the mask generation module 206 forms a mask 208.

The prompt 124 includes text specifying a shape 128 generally as “a shape” and text specifying a visual effect 130 as “melting cheese.” In response, the visual effect generation module 212 generates a visual effect 126 such that the object as the skull is replaced to have an appearance of being formed from melting cheese. The text specifying the shape 128 is also usable to support insights usable by the visual effect generation module 212 in “how” details of the visual effect are to be generated, examples of which are described as follows and shown in corresponding figures.

FIG. 7 depicts an example implementation 700 in which a text description of a shape is generalized to control visual effect generation by the visual effect generation module 212 of FIG. 2. FIG. 8 depicts an example implementation 800 in which text description of a shape is detailed as describing characteristics of the shape to control visual effect generation by the visual effect generation module 212 of FIG. 2. In the first example of FIG. 7, the text specifying the shape 128 is left purposefully vague as “a shape.” The text specifying the visual effect 130 is specified as “jadeite stone” as part of the prompt 124. This results in generation of the visual effect 126 by the visual effect generation module 212 as following a shape defined by the mask 208 but without the appearance of specific details of the chess knight.

In the second example of FIG. 8, on the other hand, the text specifying the shape 128 provides details about the portion 210, to which, the visual effect 126 is to be applied, e.g., as “a chess knight.” This causes the visual effect generation module 212 to generate the visual effect 126 to include details of a chess knight, as opposed to the generalization of FIG. 7. In this way, the visual effect generation module 212 supports user inputs to control an amount of detail applied by the visual effect generation module 212 to the portion 210 of the digital content 116, which is not possible in conventional techniques.

The machine-learning models, utilized by the visual effect generation system 120, refer to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A machine-learning model, for instance, is configurable using a plurality of layers having, respectively, a plurality of nodes. The plurality of layers is configurable to include an input layer, an output layer, and one or more hidden layers. Calculations are performed by the nodes within the layers via hidden states through a system of weighted connections that are “learned” during training of the machine-learning model to implement a variety of tasks.

In order to train the machine-learning model, training data is received that provides examples of “what is to be learned” by the machine-learning model, i.e., as a basis to learn patterns from the data. The machine-learning system, for instance, collects and preprocesses the training data that includes input features and corresponding target labels, i.e., of what is exhibited by the input features. The machine-learning system then initializes parameters of the machine-learning model, which are used by the machine-learning model as internal variables to represent and process information during training and represent interferences gained through training. In an implementation, the training data is separated into batches to improve processing and optimization efficiency of the parameters of the machine-learning model during training.

The training data is then received as an input by the machine-learning model and used as a basis for generating predictions based on a current state of parameters of layers and corresponding nodes of the model, a result of which is output as output data, e.g., a visual effect.

Training of the machine-learning model includes calculating a loss function to quantify a loss associated with operations performed by nodes of the machine-learning model. The calculating of the loss function, for instance, includes comparing a difference between predictions specified in the output data with target labels specified by the training data. The loss function is configurable in a variety of ways, examples of which include regret, Quadratic loss function as part of a least squares technique, and so forth.

Calculation of the loss function also includes use a backpropagation operation as part of minimizing the loss function and thereby training parameters of the machine-learning model. Minimizing the loss function, for instance, includes adjusting weights of the nodes in order to minimize the loss and thereby optimize performance of the machine-learning model in performance of a particular task. The adjustment is determined by computing a gradient of the loss function, which indicates a direction to be used in order to adjust the parameters to minimize the loss. The parameters of the machine-learning model are then updated based on the computed gradient.

This process continues over a plurality of iteration in an example until a stopping criterion is met. The stopping criterion is employed by the machine-learning system in this example to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, or based on performance metrics such as precision and recall.

### Example System and Device

FIG. 10 illustrates an example system generally at 1000 that includes an example computing device 1002 that is representative of one or more computing systems and/or devices that implement the various techniques described herein. This is illustrated through inclusion of the visual effect generation system 120. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The computer-readable storage medium is configured for storing instructions that, responsive to execution by the processing device, causes the processing device to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

In implementations, the platform 1016 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a processing device, a prompt including text specifying a visual effect and text specifying a shape;
forming, by the processing device, a mask defining a portion of digital content based on an object selected from the digital content;
generating, by the processing device, the visual effect using generative artificial intelligence by one or more machine-learning models based on the text specifying the visual effect, the text specifying the shape, and the mask; and
presenting, by the processing device, the digital content as having the visual effect applied to the portion of the digital content for display in a user interface.

2. The method as described in claim 1, wherein the generating the visual effect includes:
generating a contribution image embedding using generative artificial intelligence implemented using at least one said machine-learning model that is conditioned on text and image embeddings; and
generating the visual effect over one or more diffusion iterations by a diffusion model based at least in part on the contribution image embedding.

3. The method as described in claim 2, wherein the generating the visual effect over the one or more diffusion iterations includes a first said diffusion iteration in which the contribution image embedding is applied and a second said diffusion iteration in which the contribution image embedding is removed.

4. The method as described in claim 2, wherein the generating the visual effect over the one or more diffusion iterations includes adjusting an amount of noise.

5. The method as described in claim 4, wherein the adjusting is based on a user input received via a control in the user interface.

6. The method as described in claim 1, further comprising expanding the prompt to include at least one additional item of text using a machine-learning model and wherein the generating of the visual effect is further based on the at least one additional item of text.

7. The method as described in claim 1, further comprising receiving a user input selecting the object from the digital content via the user interface and wherein the generating is performed responsive to the receiving of the user input.

8. The method as described in claim 1, wherein the forming of the mask includes forming a binary mask by recoloring the portion of the digital content using a first color and remaining portions of the digital content using a second color.

9. The method as described in claim 1, wherein the digital content includes a table and the portion is defined between cells of the table.

10. The method as described in claim 1, wherein the object is a vector object.

11. The method as described in claim 10, further comprising generating the vector object from a raster object.

12. The method as described in claim 1, further comprising receiving an edit input that alters the portion of the digital content and reapplying the visual effect to the altered portion.

13. A computing device comprising:
a processing device; and
a computer-readable storage medium storing instructions that, responsive to execution by the processing device, causes the processing device to perform operations including:
receiving a prompt including text specifying a visual effect;
forming a mask defining a portion of digital content based on an object selected from digital content;
generating a contribution image embedding using generative artificial intelligence implemented using a machine-learning model that is conditioned on text and image embeddings; and
generating the visual effect by a diffusion model, the generating including one or more diffusion iterations in which the contribution image embedding is applied and at least one diffusion iteration in which the contribution image embedding is removed.

14. The computing device as described in claim 13, wherein the prompt further includes text specifying a shape and wherein the generating of the visual effect is based at least in part on the text specifying the shape.

15. The computing device as described in claim 13, wherein the digital content includes a table and the portion is defined between cells of the table.

16. One or more computer-readable storage media storing instructions that, responsive to execution by a processing device, causes the processing device to perform operations comprising:
receiving text specifying a visual effect and text specifying a shape;
forming a mask defining a portion of digital content based on an object selected from the digital content;
generating the visual effect using generative artificial intelligence by one or more machine-learning models based on the text specifying the visual effect, the text specifying the shape, and the mask; and
applying the visual effect to the portion of the digital content for display in a user interface.

17. The one or more computer-readable storage media as described in claim 16, wherein the generating the visual effect includes:
generating a contribution image embedding using generative artificial intelligence implemented using at least one said machine-learning model that is conditioned on text and image embeddings; and
generating the visual effect over one or more diffusion iterations by a diffusion model based at least in part on the contribution image embedding.

18. The one or more computer-readable storage media as described in claim 17, wherein the generating the visual effect over the one or more diffusion iterations includes a first said diffusion iteration in which the contribution image embedding is applied and a second said diffusion iteration in which the contribution image embedding is removed.

19. The one or more computer-readable storage media as described in claim 17, wherein the generating the visual effect over the one or more diffusion iterations includes adjusting an amount of noise applied to the contribution image embedding.

20. The one or more computer-readable storage media as described in claim 19, wherein the noise is Gaussian noise.
